(19) United States
(12) Patent Application Publication
(10) Pub. No.: US 2011/0069484 A1
(43) Pub. Date: Mar. 24, 2011

(54) ILLUMINATING APPARATUS

(76) Inventors: Hsiang-Chen WU, Taoyuan Hsien (TW); Chin-Ming Cheng, Taoyuan Hsien (TW)

(21) Appl. No.: 12/868,129

(22) Filed: Aug. 25, 2010

(30) Foreign Application Priority Data
Sep. 24, 2009 (TW) 98132193

(51) Int. Cl. F21V 7/00; F21V 7/06; F21V 7/08

(52) U.S. Cl. 362/235

(57) ABSTRACT

The invention provides an illuminating apparatus. The illuminating apparatus includes at least one light emitting diode (LED) and at least one reflector. The reflector, corresponding to the light emitting diode, is disposed on one side of the light emitting diode. A portion of light beams of the light emitting diode is reflected by the reflector, and a remaining portion of light beams of the light emitting diode is emitted directly to an illuminated surface.

This application claims priority of Taiwan Patent Application No. 98132193, filed on Sep. 24, 2009, the entirety of which is incorporated by reference herein.

### BACKGROUND OF THE INVENTION

1. Field of the Invention

The invention relates to an illuminating apparatus comprising at least one reflector. A portion of light beams to be emitted along an optical axis of a light emitting diode is reflected by the reflector, and a remaining portion of light beams of the light emitting diode is emitted directly to an illuminated surface.

2. Description of the Related Art

Environmental considerations is important in the development of electronic products, such as energy saving. Light emitting diodes offer benefits of a long life span, and energy saving, in addition to benefit for miniaturization and performance, such as non-blinking ability. As a result, low-powered light emitting diodes have become a major developmental focus area for the lighting industry.

Meanwhile, highly efficiency light emitting diodes are point light sources. Thus, adapting point light sources to an illuminating apparatus is a major challenge for developers. Accordingly, although there are illuminating apparatuses which utilize light emitting diodes, they are mostly designed for direct light illumination. In other words, the illuminating angle and the projecting area of current light emitting diodes are currently not satisfactorily designed, such that lamp-like LED lamps or illuminating apparatuses cannot provide significant illumination effects.

### BRIEF SUMMARY OF THE INVENTION

Accordingly, the invention provides an illuminating apparatus utilizing a light emitting diode as a light source. The angle of the light beams from the light emitting diode emitted to an illuminated surface is shifted away from an optical axis of the light emitting diode. Therefore, the illuminating apparatus may be employed in refrigerators of convenience stores for illumination of merchandises, wall washers or for other use.

The invention provides an illuminating apparatus comprising a light emitting diode. The light emitting diode includes a viewing angle. The viewing angle is the off-axis angle at which the luminous intensity is half the axial luminous intensity. The effective light beams of the light emitting diode are the light beams within the viewing angle of the light emitting diode. A portion of the effective light beams from the light emitting diode is directly emitted, and a remaining portion of the effective light beams from the light emitting diode is reflected by the reflector to be condensed, or substantially parallel to each other or combinations of being converged or substantially parallel to each other, in order to illuminate a first area away from an optical axis of the light emitting diode which is not able to be directly illuminated by the emitted light beams of the light emitting diode. That is, the light beams from the light emitting diode to the illuminated surface is shifted an angle away from the optical axis.

The invention provides an illuminating apparatus which comprises at least one light emitting diode and at least one reflector. The reflector corresponding to the light emitting diode is disposed on a side of the light emitting diode. A portion of light beams emitted along an optical axis of the light emitting diode is reflected by the reflector, and a remaining portion of light beams is emitted directly to an illuminated surface such that the illuminated surface is completely illuminated.

In a preferred embodiment, the light beams from the light emitting diode to the illuminated surface is shifted an angle away from the optical axis. A portion of effective light beams emitted along the optical axis of the light emitting diode is reflected by the first reflector, and a remaining portion of effective light beams of the light emitting diode is emitted directly, wherein an illumination angle of the effective light beams of the light emitting diode is substantially 120 degrees, that is, the viewing angle is substantially 60 degrees.

In a preferred embodiment, effective light beams of the light emitting diode directly illuminate to a first area near the optical axis, and the reflector reflects light beams from the light emitting diode to a second area away from the optical axis

Accordingly, the invention provides various illuminating apparatuses comprising all kinds of reflectors. The reflector, corresponding to at least one light emitting diode, is disposed on a side of the light emitting diode. A portion of light beams emitted along an optical axis of the light emitting diode is reflected by the reflector, and a remaining portion of light beams is emitted directly to an illuminated surface. The light beams from the light emitting diode to the illuminated surface is shifted an angle away from the optical axis. Therefore, the illuminating apparatus may be employed in refrigerators of convenience stores for illumination of merchandises, wall washers or for other use.

### BRIEF DESCRIPTION OF THE DRAWINGS

The invention can be more fully understood by reading the subsequent detailed description and examples with references made to the accompanying drawings, wherein:

FIG. 1 is a schematic view of a first embodiment of an illuminating apparatus of the invention;

FIG. 2 is a schematic view of a variant embodiment of the illuminating apparatus in FIG. 1;

FIG. 3 is a partially enlarged view of the illuminating apparatus in FIG. 1;

FIG. 4 is a sectional view of the illuminating apparatus in FIG. 1;

FIG. 5 is a schematic view of a variant embodiment of a reflector shown in FIG. 1;

FIG. 6 is a schematic view of another variant embodiment of the reflector shown in FIG. 1;

FIG. 7 is a schematic view of a second embodiment of the illuminating apparatus of the invention;

FIG. 8 is a partially enlarged view of the illuminating apparatus in FIG. 7;

FIG. 9 is a schematic view of a variant embodiment of the illuminating apparatus in FIG. 7; and

FIG. 10 is a front view of a refrigerator employing the illuminating apparatus of the invention.

### DETAILED DESCRIPTION OF THE INVENTION

### First Embodiment

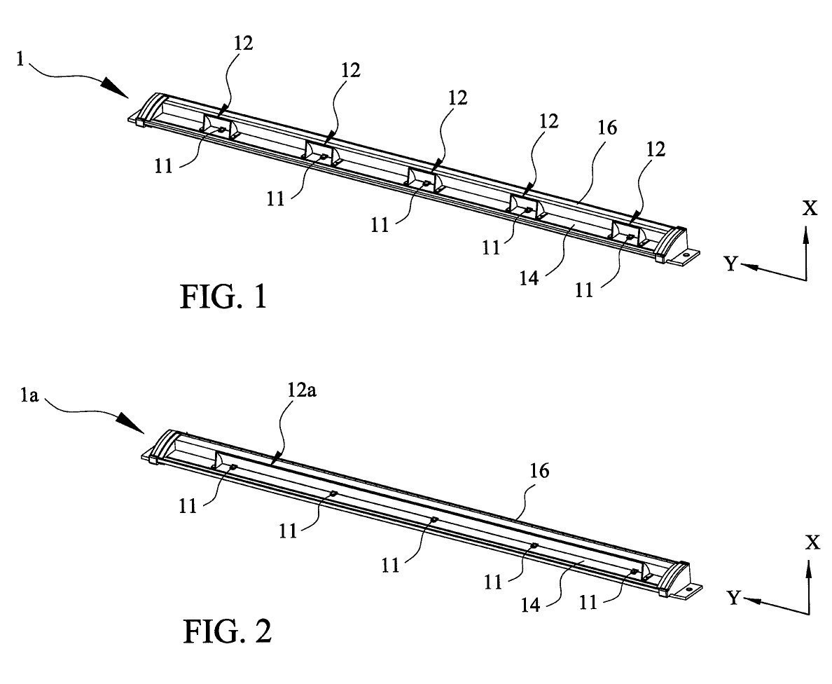

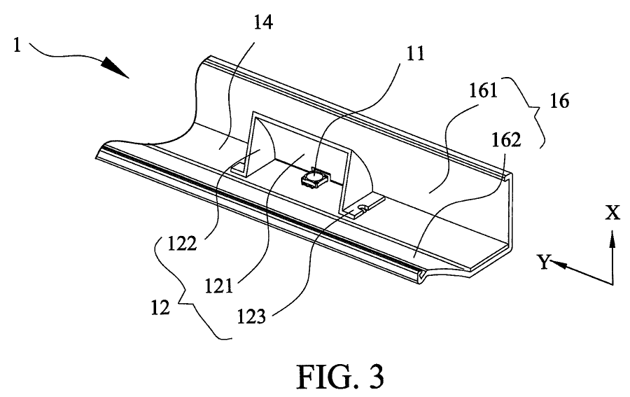

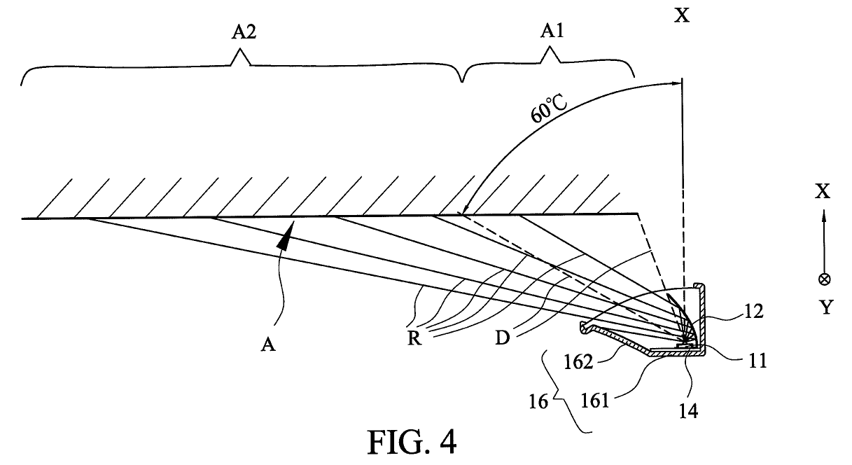

FIG. 1 is a schematic view of a first embodiment of an illuminating apparatus of the invention; FIG. 2 is a schematic view of a variant embodiment of the illuminating apparatus in FIG. 1; FIG. 3 is a partially enlarged view of the illuminating apparatus in FIG. 1; and FIG. 4 is a sectional view of the illuminating apparatus in FIG. 1. The illuminating apparatus 1 comprises at least one light emitting diode 11 and at least one reflector 12. The reflector 12 corresponding to the light emitting diode 11 is disposed on a side of the light emitting diode 11. As shown in FIG. 2, the reflector 12 of an illuminating apparatus 1a corresponds to five light emitting diodes 11, but it is not limited thereto. A portion of light beams emitted along an optical axis X of the light emitting diode 11 is reflected by the reflector 12, and a remaining portion of light beams is emitted directly to an illuminated surface of the light emitting diode A.

As shown in FIG. 4, the light emitting diode includes a viewing angle (such as 60 degrees) which is an off-axis angle at which a luminous intensity is half an axial luminous intensity, and the light emitting diode includes a plurality of effective light beams which are the light beams within the viewing angle of the light emitting diode 11. The effective light beams from the light emitting diode 11 to the illuminated surface A is shifted by an angle A from the optical axis X. A common light emitting diode has a viewing angle of substantially 60 degrees as shown in FIG. 4, but it is not limited thereto. In detail, a portion of the effective light beams substantially along the optical axis X of the light emitting diode 11 is reflected by the reflector 12, and a remaining portion of the effective light beams of the light emitting diode 11 is directly emitted. The light emitting diode 11 provides direct effective light beams D illuminating to area A1 near the optical axis X and the reflector 12 reflects light R from the light emitting diode 11 to area A2 away from the optical axis X such that the illuminated surface is completely illuminated.

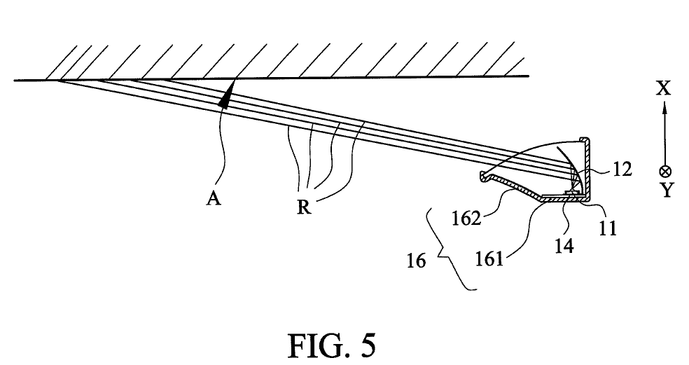

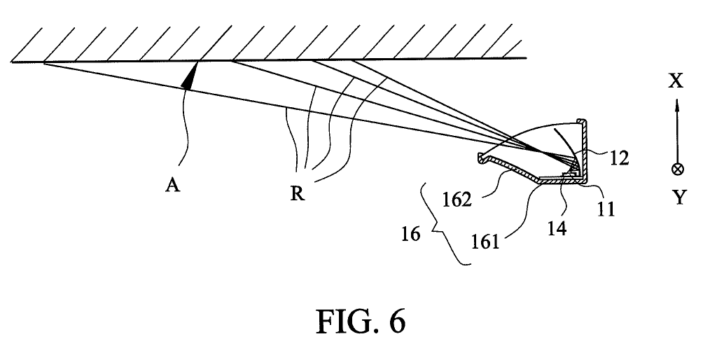

As shown in FIG. 1 to FIG. 4, the reflector 12 comprises a curved concave surface disposed on a side of the light emitting diode 11. The reflector 12 comprises a single curved cross section extending along a first direction Y perpendicular to the optical axis X. The reflector 12 comprises a curved reflecting portion 121, and the curved reflecting portion 121 comprises the curved concave surface, wherein a cross section of the curved concave surface of the reflector 12 comprises a portion of an elliptical curve (as shown in FIG. 5). The cross section of the curved concave surface extends along the first direction Y perpendicular to the optical axis X. Preferably, the light emitting diode 11 is disposed substantially at or near one of the two focus points of the elliptical curve. The light R is reflected by the reflector 12 and converged to pass through the other one of the two focus points to be projected to the illuminated surface A far away from the optical axis X. Alternatively, a cross section of the curved concave surface of the reflector 12 comprises a portion of a parabolic curve (as shown in FIG. 6). The cross section of the curved concave surface extends along the first direction Y perpendicular to the optical axis X. The light emitting diode 11 is disposed substantially at or near the focus point of the parabolic curve, and the reflected light beams from the curved concave surface are substantially parallel. Alternatively, a cross section of the curved concave surface of the reflector 12 comprises a portion of an elliptical curve connecting to a portion of a parabolic curve, but it is not limited thereto. The cross section can also be any other kinds of curves. Preferably, the reflector comprises plastic material coated with metal or plastic material covered with metal foil, but it is not limited thereto.

As shown in FIG. 3, the reflector 12 further comprises two end reflecting portions 122 respectively connecting with the two ends of the curved reflecting portion 121 and perpendicular to the curved reflecting portion 121. The reflector 12 further comprises two fixing portions 123 respectively connecting to the two end reflecting portions 122 to fasten the reflector 12.

As shown in FIG. 3, the illuminating apparatus 1 further comprises a circuit board 14. The light emitting diode 11 and the reflector 12 corresponding thereto are disposed on a surface of the circuit board 14. The reflector 12 is fastened to the surface of the circuit board 14 by the two fixing portions 123. The light emitting diode 11 is electrically connected to a printed circuit on the circuit board 14. The circuit board 14 is strip shaped and extends along the first direction Y. When the illuminating apparatus 1 comprises a plurality of light emitting diodes 11, the light emitting diodes 11 are arranged linearly on the circuit board 14.

The illuminating apparatus 1 further comprises a supporting frame 16 disposed on another surface of the circuit board 14 to support the light emitting diode 11, the reflector 12 and the circuit board 14. The supporting frame 16 comprises metal, and preferably the supporting frame 16 can be steel, iron or aluminum. The supporting frame 16 is also a heat sink and comprises heat-dissipation ability to transfer heat radiated from the light emitting diode 11. The supporting frame 16 comprises a body 161 and a reflecting portion 162. The body 161 is preferably L shaped, but it is not limited thereto. The reflecting portion 162 is disposed on the front edge of the body 161 to reflect light beams of the light emitting diode 11, and to cooperate with the reflector 12 in order to limit an illumination angle of the light emitting diode 11. The reflecting portion 162 comprises a polished metal reflecting surface. Alternatively, the reflecting portion 162 comprises another reflector (not shown), and this reflector comprises the same material as the reflector 12 (same description is omitted).

### Second Embodiment

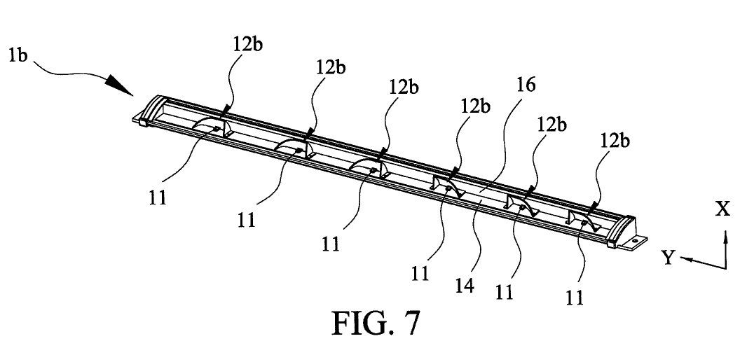

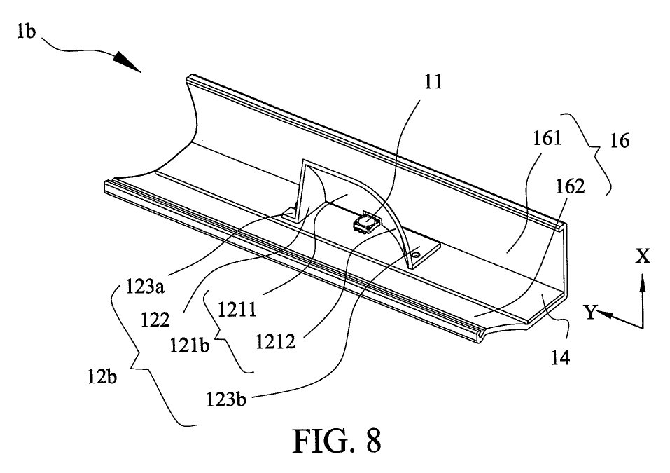

FIG. 7 is a schematic view of a second embodiment of the illuminating apparatus of the invention; and FIG. 8 is a partially enlarged view of the illuminating apparatus in FIG. 7. The illuminating apparatus 1b is similar to the illuminating apparatus 1 in the first embodiment, and the differences are described as follows. The illuminating apparatus 1b comprises a reflector 12b. The reflector 12b comprises a curved reflecting portion 121b, and the curved reflecting portion 121b comprises a first curved portion 1211 and a second curved portion 1212. The first curved portion 1211 comprises the curved concave surface as shown in the first embodiment (same description is omitted), and the second curved portion 1212 comprises an ellipsoid-like concave surface connected with the curved concave surface. The reflector 12b further comprises an end reflecting portion 122, a first fixing portion 123a and a second fixing portion 123b. The end reflecting portion 122 connects to the first fixing portion 123a and is perpendicular to the curved concave surface. The first fixing portion 123a connects to the end reflecting portion 122, and the second fixing portion 123b connects to the second curved portion 1212. The reflector 12b is fastened to the circuit board 14 by the first fixing portion 123a and the second fixing portion 123b. The illuminating apparatus 1b is preferably a strip lamp. The first curved portion 1211 (the curved concave surface) of the reflector 12b is disposed close to a center of the illuminating apparatus, and the second curved portion 1212 (the ellipsoid-like concave surface) is disposed away from the center of the illuminating apparatus. The rest of structure of the illuminating apparatus 1b is the same as the illuminating apparatus 1 in the first embodiment, and therefore the relevant descriptions are omitted.

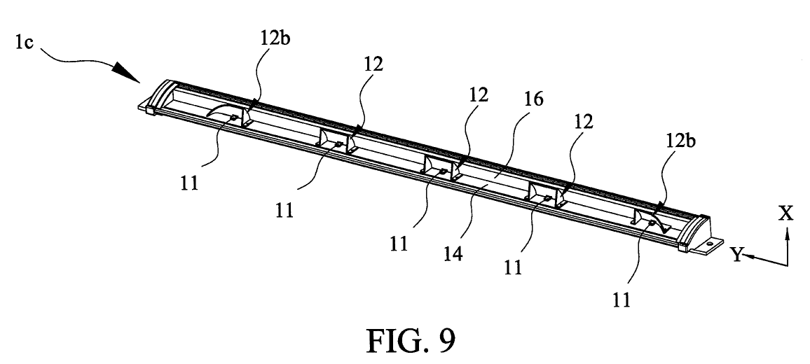

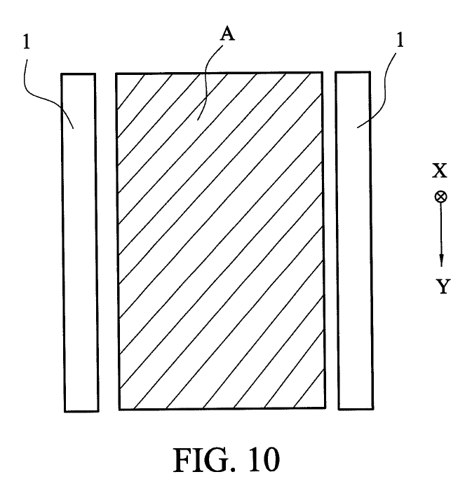

FIG. 9 is a schematic view of a variant embodiment of the illuminating apparatus in FIG. 7. The illuminating apparatus 1c is a strip lamp, and the reflectors 12b of the second embodiment are applied on two ends thereof. The rest of the applied reflectors used in the illuminating apparatus 1c are reflectors 12 of the first embodiment. The rest of the structure of the illuminating apparatus 1c is the same as the illuminating apparatus 1 of the first embodiment, and therefore the relevant descriptions are omitted hereafter.

FIG. 10 is a front view of a refrigerator employing the illuminating apparatus of the invention. The illuminating apparatuses 1, 1a, 1b and 1c as described can be disposed on a side of the illuminated surface A to illuminate the illuminated surface A. The illuminated surface is, for example, a rectangular surface. FIG. 10 depicts the illuminating apparatus disposed on two sides of the illuminated surface, but it is not limited thereto.

As described, the invention provides various illuminating apparatuses comprising all kinds of reflectors. The reflector, corresponding to at least one light emitting diode, is disposed on a side of the light emitting diode. A portion of the effective light beams of the light emitting diode is reflected by the reflector, and a remaining portion of the effective light beams is emitted directly to an illuminated surface of the light emitting diode. The effective light beams are shifted form the optical axis by an angle to the illuminated surface. Therefore, the illuminating apparatus may be employed in refrigerators of convenience stores for illumination of merchandises, wall washers or for other use.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An illuminating apparatus comprising
at least one light emitting diode; and
at least one first reflector corresponding to the light emitting diode and disposed on a side of the light emitting diode, wherein a portion of light beams emitted along an optical axis of the light emitting diode is reflected by the first reflector, and a remaining portion of light beams is emitted directly to an illuminated surface.

2. The illuminating apparatus as claimed in claim 1, wherein the light emitting diode comprises a viewing angle which is an off-axis angle at which a luminous intensity is half an axial luminous intensity, and the light emitting diode comprises a plurality of effective light beams which are the light beams within the viewing angle of the light emitting diode.

3. The illuminating apparatus as claimed in claim 2, wherein a portion of the effective light beams of the light emitting diode directly illuminate to a first area near the optical axis, and the first reflector reflects a remaining portion of the light beams of the light emitting diode to a second area away from the optical axis such that the illuminated surface is completely illuminated and the illuminated surface is shifted an angle away from the optical axis.

4. The illuminating apparatus as claimed in claim 1, wherein the first reflector comprises a curved concave surface disposed on the side of the light emitting diode.

5. The illuminating apparatus as claimed in claim 1, wherein the first reflector has a single curved cross section extending along a first direction perpendicular to the optical axis.

6. The illuminating apparatus as claimed in claim 4, wherein the first reflector comprises a curved reflecting portion and the curved reflecting portion comprises the curved concave surface.

7. The illuminating apparatus as claimed in claim 6, wherein the curved reflecting portion comprises a first curved portion and a second curved portion, the first curved portion comprises the curved concave surface, and the second curved portion comprises an ellipsoid-like concave surface connected with the curved concave surface.

8. The illuminating apparatus as claimed in claim 4, wherein a cross section of the curved concave surface of the first reflector comprises a portion of an elliptical curve, the light emitting diode is disposed at one of two focus points of the elliptical curve and the light beams are reflected from the first reflector and then converged to pass through the other one of the two focus points of the elliptical curve to project to the second area of the illuminated surface away from the optical axis.

9. The illuminating apparatus as claimed in claim 4, wherein a cross section of the curved concave surface of the first reflector comprises a portion of a parabolic curve, the light emitting diode is disposed substantially at a focus point of the parabolic curve, and the light beams reflected by the curved concave surface are substantially parallel.

10. The illuminating apparatus as claimed in claim 4, wherein a cross section of the curved concave surface of the first reflector comprises a portion of an elliptical curve connecting to a portion of a parabolic curve.

11. The illuminating apparatus as claimed in claim 6, wherein the first reflector further comprises two end reflecting portions respectively connecting with two ends of the curved reflecting portions.

12. The illuminating apparatus as claimed in claim 11, wherein the first reflector further comprises two fixing portions respectively connecting to the two end reflecting portions to fasten the first reflector.

13. The illuminating apparatus as claimed in claim 7, wherein the first reflector further comprises an end reflecting portion, a first fixing portion and a second fixing portion, and the end reflecting portion connects to the first curved portion and is perpendicular to the curved concave surface, the first fixing portion connects to the end reflecting portion, and the second fixing portion connects to the second curved portion,

14. The illuminating apparatus as claimed in claim 7, wherein the first curved portion of the first reflector is disposed close to a center of the illuminating apparatus, and the second curved portion is disposed away from the center of the illuminating apparatus.

15. The illuminating apparatus as claimed in claim 4, further comprises a third reflector correspondingly disposed on the light emitting diode on two ends of the illuminating apparatus, and the third reflector comprises the curved concave surface and an ellipsoid-like concave surface connected to the curved concave surface, and the curved concave surface of the third reflector is disposed close to a center of the illuminating apparatus, and the second curved portion is disposed away from the center of the illuminating apparatus.

16. The illuminating apparatus as claimed in claim 1, further comprising a circuit board, wherein the light emitting diode and the first reflector corresponding thereto are disposed on a surface of the circuit board, and the light emitting diode electrically connects to a printed circuit on the circuit board.

17. The illuminating apparatus as claimed in claim 16, further comprising a supporting frame disposed on another surface of the circuit board to support the light emitting diode, the first reflector and the circuit board, wherein the supporting frame has heat-dissipation ability, and the supporting frame comprises steel, iron or aluminum.

18. The illuminating apparatus as claimed in claim 17, wherein the supporting frame comprises a body and a reflecting portion, and the reflecting portion is disposed on the front edge of the body to reflect light beams of the light emitting diode, and to cooperate with the first reflector in order to limit an illumination angle of the light emitting diode.

19. The illuminating apparatus as claimed in claim 18, wherein the body is L-shaped, and the reflecting portion comprises a polished metal reflecting surface, or a second reflector is disposed on the reflecting portion.

20. The illuminating apparatus as claimed in claim 1, wherein the first reflector comprises plastic material coated with metal or plastic material covered with metal foil.
